(19) United States
(12) Patent Application Publication
(10) Pub. No.: US 2026/0058338 A1
(43) Pub. Date: Feb. 26, 2026

(54) Secondary Battery and Manufacturing Method Thereof

(71) Applicant: LG Energy Solution Ltd., Seoul (KR)

(72) Inventor: Hyun Hee Lee, Daejeon (KR)

(73) Assignee: LG Energy Solution Ltd., Seoul (KR)

(21) Appl. No.: 19/305,169

(22) Filed: Aug. 20, 2025

(30) Foreign Application Priority Data
Aug. 21, 2024 (KR) 10-2024-0112260
Jan. 22, 2025 (KR) 10-2025-0009592
Aug. 4, 2025 (KR) 10-2025-0107045

(51) Int. Cl. H01M 50/566; H01M 50/103; H01M 50/15; H01M 50/533; H01M 50/55

(52) U.S. Cl. CPC H01M 50/566; H01M 50/103; H01M 50/15; H01M 50/533; H01M 50/55

(57) ABSTRACT

A secondary battery including an electrode assembly with a positive electrode and a negative electrode; a case into which the electrode assembly is inserted; a cap plate coupled to the case; a terminal provided on the cap plate; and a collector electrically connecting the electrode assembly and the terminal is provided. The terminal and the collector are fitted into and engaged with each other, and the terminal or the collector includes a fixing projection projecting from an outer peripheral surface thereof to be inserted into the collector or the terminal.

### CROSS REFERENCES TO RELATED APPLICATIONS

This application is based on and claims the benefit of foreign priority from Korean Patent Application Nos. 10-2024-0112260, filed on Aug. 21, 2024, 10-2025-0009592, filed on Jan. 22, 2025, and 10-2025-0107045, filed on Aug. 4, 2025, in the Republic of Korea, the disclosures of which are incorporated by reference herein in their entireties.

### TECHNICAL FIELD

The present disclosure relates to a rechargeable secondary battery and a manufacturing method thereof.

### BACKGROUND

Recently, as the demand for portable electronic products such as notebook computers, video cameras, and portable telephones has rapidly increased, and as the development of electric vehicles, energy storage batteries, robots, and satellites has been accelerated, researches on high-performance secondary batteries allowing repeated charging and discharging are actively conducted.

Currently, commercially available secondary batteries include, for example, nickel-cadmium batteries, nickel-hydrogen batteries, nickel-zinc batteries, and lithium secondary batteries. Of these secondary batteries, lithium secondary batteries are gaining considerable attention due to their advantages including a substantially low memory effect to allow a high degree of freedom in charging and discharging, a very low self-discharging rate, and a high energy density, as compared to nickel-based secondary batteries.

Lithium secondary batteries mainly use lithium-based oxides and carbon materials as the positive electrode active material and the negative electrode active material, respectively. Further, lithium secondary batteries include a positive electrode plate and a negative electrode plate coated with the negative electrode active material and the negative electrode active material, respectively, an electrode assembly in which the positive electrode plate and the negative electrode plate are disposed with a separator interposed therebetween, and an outer casing for hermetically accommodating the electrode assembly together with an electrolyte.

According to the shapes of battery cases, lithium secondary batteries may be classified into can-type secondary batteries, in which the electrode assembly is mounted in a metal can, and pouch-type secondary batteries, in which the electrode assembly is mounted in a pouch of an aluminum laminate sheet. The can-type secondary batteries may be further classified into cylindrical batteries and prismatic batteries, according to the shapes of metal cans.

In the case of prismatic batteries, the terminals are connected to the electrode assembly via a current collecting member, and when the contact between the terminals and the current collecting member becomes unstable due to external vibration or shock, problems such as an increase in resistance and generation of heat may occur.

### SUMMARY

The present disclosure provides a secondary battery with an enhanced engagement strength between terminals and a current collecting member, and a manufacturing method thereof.

According to an aspect of the present disclosure, a secondary battery includes: an electrode assembly with a positive electrode and a negative electrode; a case into which the electrode assembly is inserted; a cap plate coupled to the case; a terminal provided on the cap plate; and a collector electrically connecting the electrode assembly and the terminal. The terminal and the collector are fitted into and engaged with each other, and the terminal or the collector includes a fixing projection projecting from an outer peripheral surface thereof to be inserted into the collector or the terminal, respectively.

According to an aspect of the present disclosure, the collector or the terminal may include an engagement projection that is inserted into an outer peripheral surface of the terminal or the collector.

According to an aspect of the present disclosure, a bottom surface of the collector is planar.

According to an aspect of the present disclosure, the terminal may include a protrusion that is inserted into the collector, and a recess formed in a surface thereof opposite to the protrusion.

According to an aspect of the present disclosure, in the recess, a varying inner diameter portion may be formed to have an inner diameter gradually decreasing downward.

According to an aspect of the present disclosure, an outer surface of the protrusion may have a first diameter, and an outer surface of the fixing projection may have a second diameter smaller than the first diameter.

According to an aspect of the present disclosure, an inner surface of the engagement projection may have a third diameter smaller than the second diameter and the first diameter.

According to an aspect of the present disclosure, the collector may be compressed against the protrusion to be fixed to the terminal.

According to an aspect of the present disclosure, the collector may be fixed to the protrusion by a two-step compressing process.

According to an aspect of the present disclosure, an engagement groove may be formed in an upper surface of the collector such that the protrusion is inserted thereinto, and the fixing projection may be inserted into an inner peripheral surface of the engagement groove.

According to an aspect of the present disclosure, the second battery may further include: a reinforcing member disposed under the collector, and configured to electrically connect an uncoated portion of the electrode assembly and the collector.

According to an aspect of the present disclosure, the reinforcing member may be joined to the collector by welding in a state of being bonded to the uncoated portion.

According to an aspect of the present disclosure, the terminal, the collector, and the reinforcing member may be secured by a bead, and the bead may be formed to extend from the terminal to the reinforcing member.

According to an aspect of the present disclosure, a connection groove may be formed in a lower surface of the collector, and a connection projection may be formed in the reinforcing member to be inserted into the connection groove.

According to an aspect of the present disclosure, the electrode assembly may include a plurality of positive electrode uncoated portions protruding from the positive electrode, and some of the plurality of uncoated portions may be spaced apart from each other in a longitudinal direction of the cap plate. When a width of each positive electrode uncoated portion is TW11, and a gap between the spaced positive electrode uncoated portions TG11, 1.1<TW11/TG11<2.5 may be satisfied.

According to an aspect of the present disclosure, when the width of each positive electrode uncoated portion is TW11, and a height of each positive electrode uncoated portion is TH11, 1.2<TW11/TH11<3.5 may be satisfied.

According to an aspect of the present disclosure, when the height of each positive electrode uncoated portion is TH11, and the gap between the spaced positive electrode uncoated portions is TG11, 1.01<TH11/TG11<3.1 may be satisfied.

According to an aspect of the present disclosure, when the width of each positive electrode uncoated portion is TW11, the height of each positive electrode uncoated portion is TH11, and the gap between the spaced positive electrode uncoated portions is TG11, 0.74<TW11/(TH11+TG11)<0.98 may be satisfied.

According to an aspect of the present disclosure, the width of each positive electrode uncoated portion may be about 21 mm to 49 mm, the height of each positive electrode uncoated portion may be about 13 mm to 33 mm, and the gap between the spaced positive electrode uncoated portions may be about 5 mm to 31 mm.

According to another aspect of the present disclosure, a secondary battery includes: an electrode assembly with a positive electrode and a negative electrode; a case into which the electrode assembly is inserted; a cap plate coupled to the case; a terminal provided on the cap plate; and a collector configured to electrically connect the terminal and the electrode assembly, and fixed to the terminal by compression.

According to yet another aspect of the present disclosure, a method of manufacturing a secondary battery includes: a first compressing step of pressing a terminal toward a collector or pressing the collector toward the terminal, by using a first presser in a state where the terminal and the collector are disposed in contact with each other, thereby engaging the collector and the terminal with each other; and a second compressing step of pressing a lower surface of the collector or an upper surface of the terminal, by using a second presser in a state where the first presser is engaged with the terminal or the collector.

According to an aspect of the present disclosure, in the first compressing step, in a state where the terminal and the collector are placed on a die with a recessed space, a pressing projection formed in the first presser may be inserted into a recess formed in the terminal to press the terminal, and an engagement groove may be formed in the collector such that a protrusion of the terminal is inserted thereinto.

According to an aspect of the present disclosure, in a lower end of the first presser, a tapered portion may be formed to have an outer diameter gradually decreasing downward, and in the first compressing step, a varying inner diameter portion may be formed in the recess to have an inner diameter gradually decreasing toward a bottom of the recess.

According to an aspect of the present disclosure, in the first compressing step, a fixing projection may be formed to project from an outer peripheral surface of the protrusion and be inserted into the engagement groove, and an engagement projection may be formed to project from an inner surface of the engagement groove and be inserted into the outer peripheral surface of the protrusion, and in the second compressing step, a height of the fixing projection and the engagement projection may be reduced.

According to an aspect of the present disclosure, the method may further include a welding step of, in a state where a plate-shaped reinforcing member is stacked under the collector, bonding the terminal, the collector, and the reinforcing member by welding, and in the welding step, a bead may be formed to extend from the terminal to the reinforcing member.

In the secondary battery according to an embodiment of the present disclosure, the fixing projection is formed on the outer peripheral surface of the terminal, and inserted into the current collecting member, so that the engagement relationship between the current collecting member and the terminal may be enhanced.

Further, the terminal and the current collecting member are fixed by compressing, and the fixing projection and the engagement projection are formed during the compressing process, so that the engagement strength between the terminal and the current collecting member may be enhanced, and furthermore, the manufacturing efficiency may be improved.

### BRIEF DESCRIPTION OF THE DRAWINGS

The drawings attached herewith are merely illustrative of embodiments of the present disclosure, and take on the role of further facilitating the understanding of the technical idea of the present disclosure along with the descriptions herein. Thus, the present disclosure should not be construed as being limited to those illustrated in the drawings.

FIG. 1 is a perspective view illustrating a secondary battery according to a first embodiment of the present disclosure.

FIG. 2 is a perspective view illustrating a state where a portion of the secondary battery of FIG. 1 is disassembled.

FIG. 3 is a cross-sectional view cut along line III-III in FIG. 1.

FIG. 4 is a view illustrating a state where a first terminal, a current collecting member, and a reinforcing member are engaged according to the first embodiment of the present disclosure.

FIG. 5 is an enlarged view of area A1 in FIG. 4.

FIG. 6 is a view illustrating a state where a second terminal, a current collecting member, and a reinforcing member are engaged according to the first embodiment of the present disclosure.

FIG. 7 is an exploded cross-sectional view illustrating a portion according to a second embodiment of the present disclosure.

FIG. 8 is a cross-sectional view illustrating a state where a terminal is engaged with a current collecting member according to a third embodiment of the present disclosure.

FIG. 9 is a view illustrating a state where a current collecting member and a reinforcing member are separated according to the third embodiment of the present disclosure.

FIG. 10 is a cross-sectional view illustrating a state where a terminal and a current collecting member are engaged according to a fourth embodiment of the present disclosure.

FIG. 11 is a cross-sectional view illustrating a state where a terminal and a current collecting member are engaged according to a fifth embodiment of the present disclosure.

FIG. 12 is a cross-sectional view illustrating a state where a terminal and a current collecting member are engaged according to a sixth embodiment of the present disclosure.

FIG. 13 is a view illustrating the current collecting member according to the sixth embodiment of the present disclosure.

FIG. 14 is a view illustrating a current collecting member according to a seventh embodiment of the present disclosure.

FIG. 15 is a cross-sectional view illustrating a state where a terminal and a current collecting member are engaged according to an eighth embodiment of the present disclosure.

FIG. 16 is a view illustrating the current collecting member according to the eighth embodiment of the present disclosure.

FIG. 17 is a view illustrating a state where a terminal and a current collecting member are placed on a die according to embodiments of the present disclosure.

FIG. 18 is a view illustrating a first compressing step according to embodiments of the present disclosure.

FIG. 19 is a view illustrating a second compressing step according to embodiments of the present disclosure.

FIG. 20 is a flowchart illustrating a method of manufacturing a secondary battery according to embodiments of the present disclosure.

In some of the accompanying drawings, corresponding components will be denoted with the same reference numerals. The drawing figures presented are illustrated for simplicity and clarity and have not necessarily been drawn to scale. For example, the dimensions of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments.

### DETAILED DESCRIPTION

Since the present disclosure may be subjected to various modifications and include various embodiments, specific embodiments of the present disclosure will be described in detail. However, the present disclosure is not limited to the specific embodiments, but should be construed as including all modifications, equivalents, or substitutions that fall within the technical idea and scope of the present disclosure.

Terms used herein below are merely intended to describe the specific embodiments, and are not intended to limit the present disclosure. A singular expression includes the plural unless the context clearly indicates otherwise. In the descriptions herein below, terms such as “include” and “have” are intended to designate the presence of features, numerals, steps, operations, components, parts, and combinations thereof described herein, but should not be interpreted to exclude the presence or possible addition of one or more other features, numerals, steps, operations, components, parts, and combinations thereof.

Hereinafter, embodiments of the present disclosure will be described with reference to the accompanying drawings. It should be noted that in the accompanying drawings, identical components are denoted with the same reference numerals as possible. Further, detailed descriptions of well-known functions and configurations will be omitted if determined to obscure the gist of the present disclosure. For the same reason, some components may be exaggerated, omitted, or schematically illustrated in the accompanying drawings.

Hereinafter, a secondary battery according to an embodiment of the present disclosure will be described.

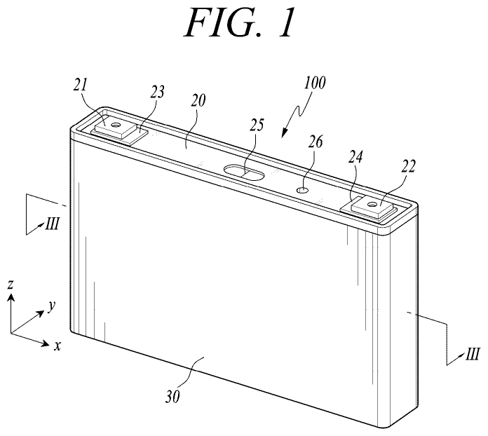

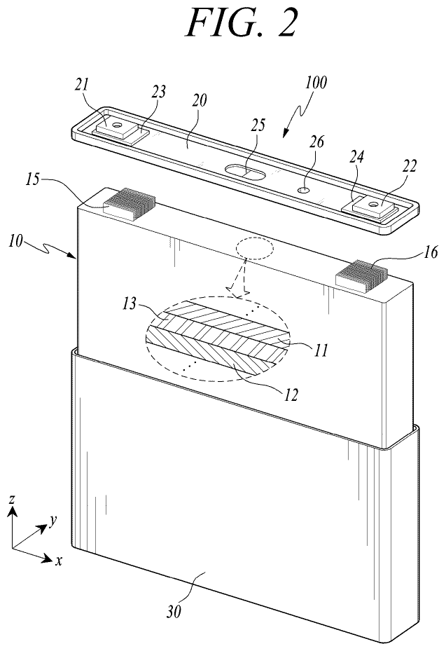

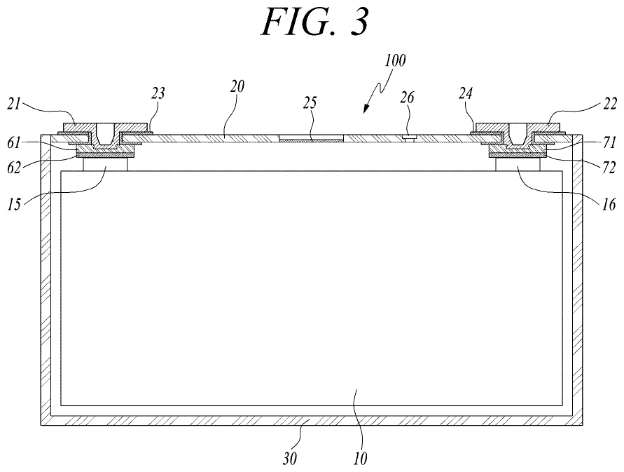

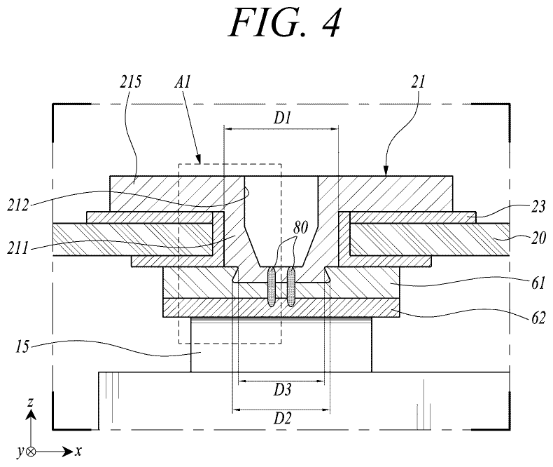

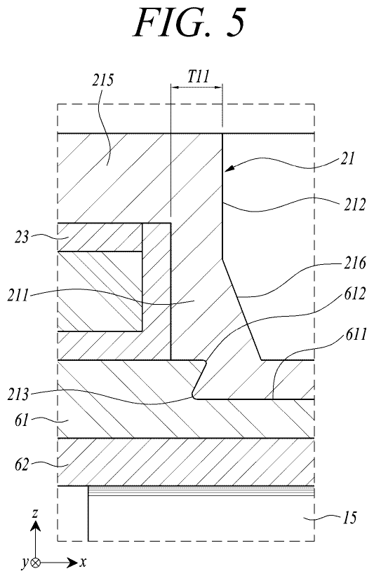

FIG. 1 is a perspective view illustrating a secondary battery according to a first embodiment of the present disclosure. FIG. 2 is a perspective view illustrating a state where a portion of the secondary battery of FIG. 1 is disassembled. FIG. 3 is a cross-sectional view cut along the line III-III in FIG. 1. FIG. 4 is a view illustrating a state where a terminal, a current collecting member, and a reinforcing member are engaged according to the first embodiment of the present disclosure. FIG. 5 is an enlarged view of the area A1 in FIG. 4.

Referring to FIGS. 1 to 5, a secondary battery 100 according to the present embodiment includes an electrode assembly 10 including a positive electrode 11 and a negative electrode 12, a case 30 accommodating the electrode assembly 10, a cap plate 20 coupled to the case 30, terminals 21 and 22 provided on the cap plate 20, and current collecting members 61 and 71 electrically connecting the terminals 21 and 22 provided on the cap plate 20 to the electrode assembly 10.

The electrode assembly 10 includes the positive electrode 11, the negative electrode 12, and a separator 13 disposed between the positive electrode 11 and the negative electrode 12, and the positive electrode 11, the separator 13, and the negative electrode 12 may be provided in a stacked structure or wound in a jelly roll form. Further, the electrode assembly 10 may have a structure in which the positive electrode 11 and the negative electrode 12 are alternately inserted between sheets of the separator 13 bent in a zigzag shape. Further, the electrode assembly 10 may be manufactured in various forms such as an all-solid-state type.

Each of the positive electrode 11 and the negative electrode 12 may include a coated portion that is a region of a metal foil to which an active material is applied, and an uncoated portion where no active material is applied. A positive electrode uncoated portion 15 may protrude from the side end of the positive electrode 11, and a negative electrode uncoated portion 16 may protrude from the side end of the negative electrode 12. The positive electrode uncoated portion 15 and the negative electrode uncoated member 16 may protrude in the same direction, for example, in the direction toward the cap plate 20 (z-axis direction).

The positive electrode uncoated portion 15 and the negative electrode uncoated portion 16 are formed in a tab shape, and may be spaced apart from each other in the width direction of the case 30 (x-axis direction). Positive electrode uncoated portions 15 and negative electrode uncoated portions 16 may be stacked in the thickness direction of the case 30 (y-axis direction).

Further, the positive electrode uncoated portion 15 may be connected to the first terminal 21 via the current collecting member 61, and the negative electrode uncoated portion 16 may be connected to the second terminal 22 via the current collecting member 71.

The separator 13 is disposed between the positive electrode 11 and the negative electrode 12, to prevent or suppress short circuits and allow the movement of ions. When the secondary battery 100 is an all-solid-state battery, a solid electrolyte, instead of the separator 13, may be disposed between the positive electrode 11 and the negative electrode 12.

The case 30 may be formed in a box shape with an interior space for accommodating the electrode assembly 10. The case 30 may be formed in various shapes such as a prismatic shape and a cylindrical shape. A single electrode assembly 10 may be inserted into the case 30, or a plurality of electrode assemblies 10 may be inserted into the case 30.

Together with the electrode assembly 10, an electrolyte solution may be accommodated in the case 10. The electrolyte solution may be provided in a liquid, solid, or gel state.

The cap plate 20 is made of a plate material covering an opening of the case 30, and may have a shape corresponding to the shape of the opening of the case 30. The cap plate 20 may be fixed to the case 30 through welding.

The cap plate 20 may be provided with a sealing cap 26 that plugs an electrolyte injection port, and a vent unit 25 that opens at a predetermined internal pressure. However, the present disclosure is not limited thereto, and the vent unit 25 may be formed in the side or bottom surface of the case 30.

The terminals 21 and 22 are coupled to the cap plate 20, and one or two terminals 21 and 22 may be provided on the cap plate 20. When two terminals 21 and 22 are provided on the cap plate 20, the first terminal 21 may act as a positive electrode terminal, and the second terminal 22 may act as a negative electrode terminal. When one terminal is provided on the cap plate 20, the case 30 may be charged as a negative electrode.

The first terminal 21 and the second terminal 22 may be formed in a plate shape. A gasket 23 for electrical insulation may be provided between the first terminal 21 and the cap plate 20, and a gasket 24 for electrical insulation may be provided between the second terminal 22 and the cap plate 20. The gaskets 23 and 24 may extend downwardly to be also located between the current collecting members 61 and 71 and the cap plate 20. Each of the gaskets 23 and 24 may be formed as a single member, or may be divided into a plurality of members.

The first terminal 21 is electrically connected to the positive electrode uncoated portion 15 via the current collecting member 61 and the reinforcing member 62, and the second terminal 22 is electrically connected to the negative electrode uncoated portion 16 via the current collecting member 71 and the reinforcing member 72.

The reinforcing member 62 may be bonded to the upper surface or upper end of the positive electrode uncoated portion 15 by welding, and the reinforcing member 72 may be bonded to the upper surface or upper end of the negative electrode uncoated portion 16 by welding.

The first terminal 21 may include a plate-shaped base plate 215 and a protrusion 211 protruding downwardly from the base plate 215 to be inserted into a terminal hole formed in the cap plate 20.

Further, the first terminal 21 may include a recess 212 formed in the surface thereof opposite to the protrusion 211. The base plate 215 is disposed on the outer side of the cap plate 20, and the protrusion 211 may be inserted into the cap plate 20 and protrude into the case 30. The protrusion 211 may be formed in a substantially cylindrical shape.

The recess 212 includes a varying inner diameter portion 216 of which the inner diameter gradually decreases downward, and the varying inner diameter portion 216 may be formed in the lower portion of the recess 212. The protrusion 211 may be inserted into the case 30 through the terminal hole, and engaged with the current collecting member 61. The protrusion 211 is compressed in a state of being in contact with the current collecting member 61, so that the first terminal 21 and the current collecting member 61 may be engaged with each other. The protrusion 211 may be firmly engaged with the current collecting member 61 through two compressing processes.

The first terminal 21 may include a fixing projection 213 projecting from the outer peripheral surface thereof to be inserted into the current collecting member 61, and the fixing projection 213 may project from the outer peripheral surface of the protrusion 211. The fixing projection 213 may be formed extending in the circumferential direction of the protrusion 211. The fixing projection 213 may be located on the lower end of the protrusion 211. The fixing projection 213 may be formed in the process of compressing the protrusion, and may be formed through a two-step compressing process. The tubular portion of the protrusion 211 may be formed by tension, and the bottom of the protrusion 211 may be formed by compression. Accordingly, the density of the bottom may be greater than the density of the tubular portion.

An engagement groove 611 is formed in the upper surface of the current collecting member 61 such that the protrusion 211 is inserted thereinto, and the fixing projection 213 may be inserted into the inner peripheral surface of the engagement groove 611. Thus, the current collecting member 61 and the first terminal 21 may be fitted into and engaged with each other. The engagement groove 611 may be formed such that the cross-sectional area at the bottom thereof is larger than that at the opening, and the cross-sectional area thereof increases gradually from the opening to the bottom. In the current collecting member 61, the density of the bottom of the engagement groove 611 may be greater than the density of the outer portion of the engagement groove 611.

Further, the current collecting member 61 may include an engagement projection 612 that is inserted into the outer peripheral surface of the first terminal 21. The engagement projection 612 is located on the fixing projection 213, and the fixing projection 213 and the engagement projection 612 may support each other by being abutted against each other. Further, the engagement projection 612 may be formed in the upper portion of the engagement groove 611.

The outer surface of the protrusion 211 has a first diameter D1, and the outer surface of the fixing protrusion 213 has a second diameter D2 smaller than the first diameter D1. Here, the second diameter D2 refers to the diameter of the most outwardly projecting portion of the fixing projection 213. The inner end of the engagement projection 612 has a third diameter D3 smaller than the second diameter D2 and the first diameter D1, and the third diameter D3 refers to the diameter of the most inwardly projecting portion of the engagement projection 612. In this way, when the inner end of the engagement projection 612 has the third diameter D3 smaller than the second diameter D2 and the first diameter D1, the engagement projection 612 may reliably prevent or suppress the disengagement of the first terminal 21, and the current collecting member 61 and the first terminal 21 may be reliably engaged with each other.

The reinforcing member 62 may be disposed under the current collecting member 61, and joined to the current collecting member 61 by welding. The reinforcing member 62 is formed in a plate shape, and electrically connects the positive electrode uncoated portion 15 and the current collecting member 61. Further, the reinforcing member 62 is bonded to the positive electrode uncoated portion 15 to enhance the mechanical strength of the positive electrode uncoated portion 15.

The lower surface of the current collecting member 61 may be formed as a flat plane by pressing, and the reinforcing member 62 may be welded to the positive electrode uncoated portion 15. When the lower surface of the current collecting member 61 is formed as a flat plane, the plate-shaped current collecting member 61 and the reinforcing member 62 may be easily bonded to each other. In the state where the current collecting member 61 is engaged with the first terminal 21, and the reinforcing member 62 is bonded to the positive electrode uncoated portion 15, the current collecting member 61 and the reinforcing member 62 may be bonded to each other by welding.

In the state where the reinforcing member 62 is stacked on the bottom of the plane-shaped current collecting member 61, a laser may be irradiated through the recess 212 of the first terminal 21 so that the first terminal 21, the current collecting member 61, and the reinforcing member 62 may be welded at once. At this time, a bead 80 is formed to extend from the first terminal 21 to the reinforcing member 62 through the current collecting member 61. Thus, the first terminal 21, the current collecting member 61, and the reinforcing member 62 may be secured by the single bead 80.

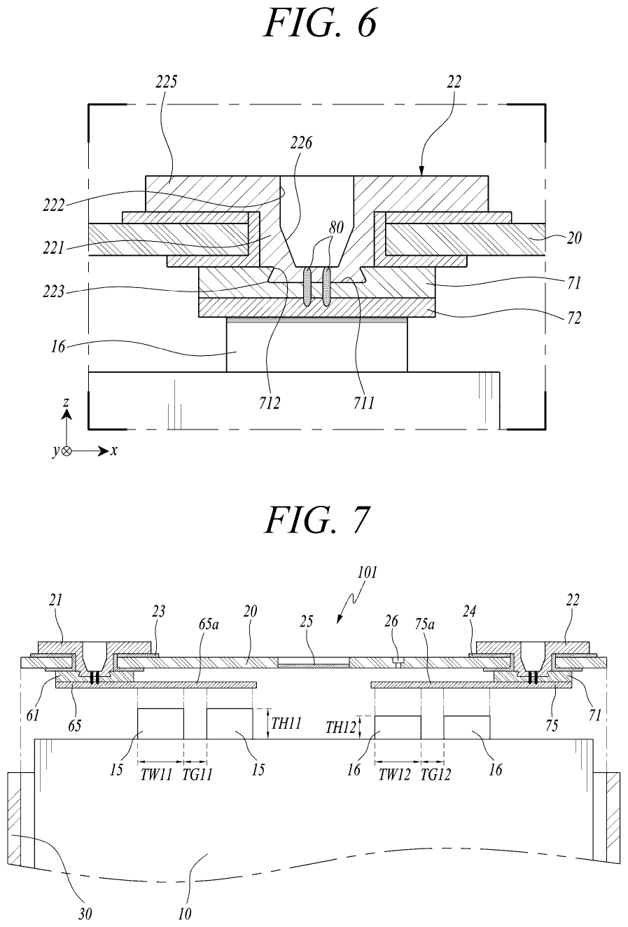

FIG. 6 is a view illustrating a state where the second terminal, the current collecting member, and the reinforcing member are engaged according to the first embodiment of the present disclosure.

Hereinafter, the second terminal 22 will be described with reference to FIG. 6. Since the second terminal 22, the current collecting member 71, and the reinforcing member 72 have a similar structure to that of the first terminal 21, the current collecting member 61, and the reinforcing member 62, overlapping descriptions of the same structure will be omitted.

The second terminal 22 may include a plate-shaped base plate 225, and a protrusion 221 protruding downwardly from the base plate 225 to be inserted into a terminal hole formed in the cap plate 20.

Further, the second terminal 22 may include a recess 222 formed in the surface thereof opposite to the protrusion 221. The base plate 225 is disposed on the outer side of the cap plate 20, and the protrusion 221 may be inserted into the cap plate 20 and protrude into the case 30. The protrusion 221 may be formed in a substantially cylindrical shape.

The recess 222 includes a varying inner diameter portion 226 of which the inner diameter gradually decreases downward, and the varying inner diameter portion 226 may be formed in the lower portion of the recess 222. The protrusion 221 may be inserted into the case 30 through the terminal hole, and engaged with the current collecting member 71. The protrusion 221 is compressed in a state of being in contact with the current collecting member 71, so that the second terminal 22 and the current collecting member 71 may be engaged with each other. The protrusion 221 may be firmly engaged with the current collecting member 71 through two compressing processes.

The second terminal 22 may include a fixing projection 223 projecting from the outer peripheral surface thereof to be inserted into the current collecting member 71, and the fixing projection 223 may project from the outer peripheral surface of the protrusion 221. The fixing projection 223 may be formed extending in the circumferential direction of the protrusion 221. The fixing projection 223 may be located on the lower end of the protrusion 221. The fixing projection 223 may be formed in the process of compressing the protrusion, and may be formed through a two-step compressing process. The tubular portion of the protrusion 221 may be formed by tension, and the bottom of the protrusion 221 may be formed by compression.

An engagement groove 711 is formed in the upper surface of the current collecting member 71 such that the protrusion 221 is inserted thereinto, and the fixing projection 223 may be inserted into the inner peripheral surface of the engagement groove 711. Thus, the current collecting member 71 and the second terminal 22 may be fitted into and engaged with each other. The engagement groove 711 may be formed such that the cross-sectional area at the bottom thereof is larger than that at the opening, and the cross-sectional area thereof increases gradually from the opening to the bottom.

Further, the current collecting member 71 may include an engagement projection 712 that is inserted into the outer peripheral surface of the second terminal 22. The engagement projection 712 is located on the fixing projection 223, and the fixing projection 223 and the engagement projection 712 may support each other by being abutted against each other. Further, the engagement projection 712 may be formed in the upper portion of the engagement groove 711.

The reinforcing member 72 may be disposed under the current collecting member 71, and joined to the current collecting member 71 by welding. The reinforcing member 72 is formed in a plate shape, and electrically connects the negative electrode uncoated portion 16 and the current collecting member 71. Further, the reinforcing member 72 is bonded to the negative electrode uncoated portion 16 to enhance the mechanical strength of the negative electrode uncoated portion 16. The lower surface of the current collecting member 71 may be pressed to be formed as a flat plane, and the reinforcing member 72 may be welded to the negative electrode uncoated portion 16.

The current collecting member 71 and the reinforcing member 72 may be made of the same material, and the second terminal 22 may be made of a different material from that of the current collecting member 71 and the reinforcing member 72. For example, the current collecting member 71 and the reinforcing member 72 may be made of copper, and the second terminal 22 may be made of aluminum.

As described above, according to the first embodiment, the current collecting members 61 and 71 and the terminals 21 and 22 are compressed and engaged with each other, so that the contact between the current collecting members 61 and 71 and the terminals 21 and 22 may be prevented or suppressed from becoming unstable due to external shock or vibration. Further, the fixing projections 213 and 223 and the engagement projections 612 and 712 are formed, so that the engagement strength between the terminals 21 and 22 and the current collecting members 61 and 71 may be further enhanced. Further, after the reinforcing members 62 and 72 are welded to the uncoated portions 15 and 16, and the current collecting members 61 and 71 are compressed against the terminals 21 and 22, the terminals 21 and 22, the reinforcing members 62 and 72, and the current collecting members 61 and 71 are welded at once, so that the manufacturing efficiency may be significantly improved.

Hereinafter, a secondary battery according to a second embodiment of the present disclosure will be described.

FIG. 7 is an exploded cross-sectional view illustrating a portion according to the second embodiment of the present disclosure.

Referring to FIG. 7, since a secondary battery 101 according to the second embodiment has the same structure as that of the secondary battery according to the first embodiment described above, except for the reinforcing member 62 and electrode tabs, overlapping descriptions of the same structure will be omitted.

The electrode assembly 10 may include two bundles of positive electrode uncoated portions. One positive electrode may be provided with two positive electrode uncoated portions 15, and positive electrode uncoated portions 15 may be stacked to form two bundles of positive electrode uncoated portions. Alternatively, one positive electrode may be provided with one positive electrode uncoated portion 15 while positive electrode uncoated portions 15 provided in positive electrodes may be disposed at different positions, such that stacked positive electrode uncoated portions 15 may form two bundles of positive electrode uncoated portions.

When the width of each positive electrode uncoated portion 15 is TW11, and the gap between the positive electrode uncoated portions 15 is TG11, 1.1<TW11/TG11<2.5 may be satisfied. Here, the gap TG11 between the positive electrode uncoated portions 15 refers to the spaced distance in the longitudinal direction of the cap plate 20. That is, the width TW11 of each positive electrode uncoated portion 15 may be larger than the gap TG11 between the positive electrode uncoated portions 15, and may be about 1.1 times to 2.5 times the gap TG11 between the positive electrode uncoated portions 15. Here, the width TW11 of each positive electrode uncoated portion 15 may be about 21 mm to 49 mm, and the gap TG11 between the positive electrode uncoated portions 15 may be about 5 mm to 31 mm.

When the width of each positive electrode uncoated portion 15 is TW11, and the height of each positive electrode uncoated portion 15 is TH11, 1.2<TW11/TH11<3.5 may be satisfied. That is, the width TW11 of each positive electrode uncoated portion 15 may be larger than the height TH11 of each positive electrode uncoated portion 15, and may be about 1.2 times to 3.5 times the height TH11 of each positive electrode uncoated portion 15. Here, the width TW11 of each positive electrode uncoated portion 15 may be about 21 mm to 49 mm, and the height TH11 of each positive electrode uncoated portion 15 may be about 13 mm to 33 mm.

When the height of each positive electrode uncoated portion 15 is TH11, and the gap between the positive electrode uncoated portions 15 is TG11, 1.01<TH11/TG11<3.1 may be satisfied. That is, the height TH11 of each positive electrode uncoated portion 15 may be about 1.01 times to 3.1 times the gap TG11 between the positive electrode uncoated portions 15. Here, the height TH11 of each positive electrode uncoated portion 15 may be about 13 mm to 33 mm, and the gap TG11 between the positive electrode uncoated portions 15 may be about 5 mm to 31 mm.

Meanwhile, when the width of each positive electrode uncoated portion 15 is TW11, the height of each positive electrode uncoated portion 15 is TH11, and the gap between the positive electrode uncoated portions 15 is TG11, 0.74<TW11/(TH11+TG11)<0.98 may be satisfied.

Further, the electrode assembly 10 may include two bundles of negative electrode uncoated portions. One negative electrode may be provided with two negative electrode uncoated portions 16, or one negative electrode may be provided with one negative electrode uncoated portion 16 while negative electrode uncoated portions 16 provided in negative electrodes may be disposed at different positions, to form two bundles of negative electrode uncoated portions.

Here, when the width of each negative electrode uncoated portion 16 is TW12, the height of each negative electrode uncoated portion 16 is TH12, and the gap between the negative electrode uncoated portions 16 is TG12, 0.74<TW12/(TH12+TG12)<0.98 may be satisfied.

Further, the width TW12 of each negative electrode uncoated portion 16 and the gap TG12 between the negative electrode uncoated portions 16 may satisfy 1.01<TH12/TG12<3.1, and the width TW12 of each negative electrode uncoated portion 16 and the height TH12 of each negative electrode uncoated portion 16 may satisfy 1.2<TW12/TH12<3.5. Further, the height TH12 of each negative electrode uncoated portion 16 and the gap G12 between the negative electrode uncoated portions 16 may satisfy 1.01<TH12/TG12<3.1.

The reinforcing member 65 may be disposed under the current collecting member 61, and joined to the current collecting member 61 by welding. The reinforcing member 65 is formed in a plate shape, and electrically connects the positive electrode uncoated portions 15 and the current collecting member 61. Further, the reinforcing member 65 is bonded to the positive electrode uncoated portions 15 to enhance the mechanical strength of the positive electrode uncoated portions 15.

The reinforcing member 65 may be formed to be longer than the current collecting member 61. The reinforcing member 65 may include a connection projection 65a that projects beyond the current collecting member 61 in the longitudinal direction of the cap plate 20. The positive electrode uncoated portions 15 described above may be joined to the connection protrusion 65a by welding.

Meanwhile, the reinforcing member 75 bonded to the current collecting member 71 may be welded to the negative electrode uncoated portions 16. When the lower surface of the current collecting member 71 is formed as a plane surface, the plate-shaped current collecting member 71 and the reinforcing member 75 may easily be bonded to each other.

The reinforcing member 75 may be formed to be longer than the current collecting member 71. The reinforcing member 75 may include a connection projection 75a that projects beyond the current collecting member 71 in the longitudinal direction of the cap plate 20. The negative electrode uncoated portions 16 described above may be joined to the connection protrusion 75a by welding.

Hereinafter, a secondary battery according to a third embodiment of the present disclosure will be described.

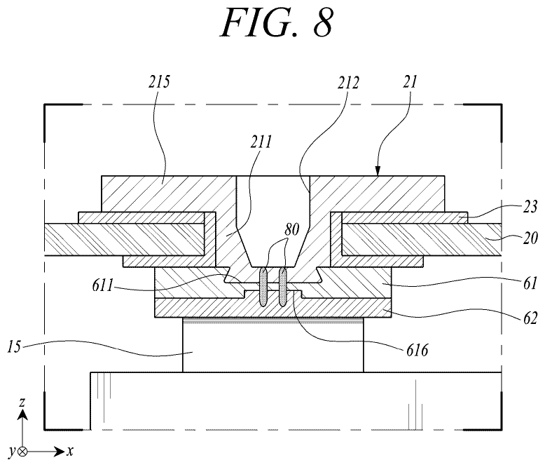

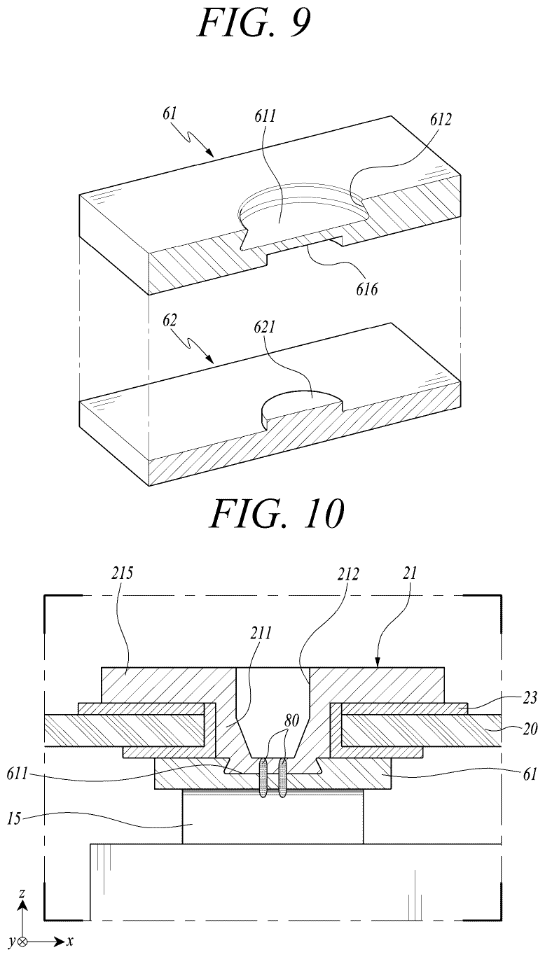

FIG. 8 is a cross-sectional view illustrating a state where a terminal is engaged with a current collecting member according to the third embodiment of the present disclosure, and FIG. 9 is a view illustrating a state where a current collecting member and a reinforcing member are separated according to the third embodiment of the present disclosure.

Referring to FIGS. 8 and 9, since the secondary battery according to the present embodiment has the same structure as the secondary battery according to the first embodiment described above, except for the current collecting member 61 and the reinforcing member 62, overlapping descriptions of the same structure will be omitted.

The first terminal 21 may include the plate-shaped base plate 215, and the protrusion 211 protruding downwardly from the base plate 215 to be inserted into the terminal hole formed in the cap plate 20. Further, the first terminal 21 may include the recess 212 formed in the surface thereof opposite to the protrusion 211.

The engagement groove 611 may be formed in the upper surface of the current collecting member 61 such that the protrusion 211 is inserted into. The plate-shaped current collecting member 61 and the reinforcing member 62 are disposed under the first terminal 21, and the current collecting member 61 may be engaged with the protrusion 211 of the first terminal 21 by compression.

A connection groove 616 may be formed in the lower surface of the current collecting member 61, and a connection projection 621 may be formed on the upper surface of the reinforcing member 62 to be inserted into the connection groove 616. The reinforcing member 62 is formed in a plate shape, and may be bonded to the positive electrode uncoated portion 15.

In the state where the connection projection 621 of the reinforcing member 62 is inserted into the connection groove 616, a laser may be irradiated through the recess 212 of the first terminal 21 so that the first terminal 21, the current collecting member 61, and the reinforcing member 62 may be welded at once. At this time, the bead 80 is formed to extend from the terminal 21 to the reinforcing member 62 through the current collecting member 61, and the terminal 21, the current collecting member 61, and the reinforcing member 62 may be secured by the single bead 80.

When the connection groove 616 is formed in the current collecting member 61, and the connection projection 621 is formed in the reinforcing member 62 as in the present embodiment, the terminal 21, the current collecting member 61, and the reinforcing member 62 may be more easily welded.

Hereinafter, a secondary battery according to a fourth embodiment of the present disclosure will be described.

FIG. 10 is a cross-sectional view illustrating a state where a terminal is engaged with a current collecting member according to the fourth embodiment of the present disclosure.

Referring to FIG. 10, since the secondary battery according to the present embodiment has the same structure as that of the secondary battery according to the first embodiment described above, except that the reinforcing member is omitted, overlapping descriptions of the same structure will be omitted.

The first terminal 21 may include the plate-shaped base plate 215, and the protrusion 211 protruding downwardly from the base plate 215 to be inserted into a terminal hole formed in the cap plate 20. Further, the first terminal 21 may include the recess 212 formed in the surface thereof opposite to the protrusion 211.

The engagement groove 611 may be formed in the upper surface of the current collecting member 61 such that the protrusion 211 is inserted thereinto. The current collecting member 61 may be engaged with the protrusion 211 of the first terminal 21 by compression.

The positive electrode uncoated portion 15 is disposed under the current collecting member 61, and the current collecting member 61 may be directly bonded to the positive electrode uncoated portion 15 without the reinforcing member.

In the state where the current collecting member 61 is stacked on the upper end of the positive electrode uncoated portion 15, a laser may be irradiated through the recess 212 of the first terminal 21 so that the terminal 21 and the current collecting member 61 may be welded at once. At this time, the bead 80 may be formed to extend from the terminal 21 to the positive electrode uncoated portion 15 through the current collecting member 61, so that the terminal 21, the current collecting member 61, and the positive electrode uncoated portion 15 may be secured by the single bead 80.

Hereinafter, a secondary battery according to a fifth embodiment of the present disclosure will be described.

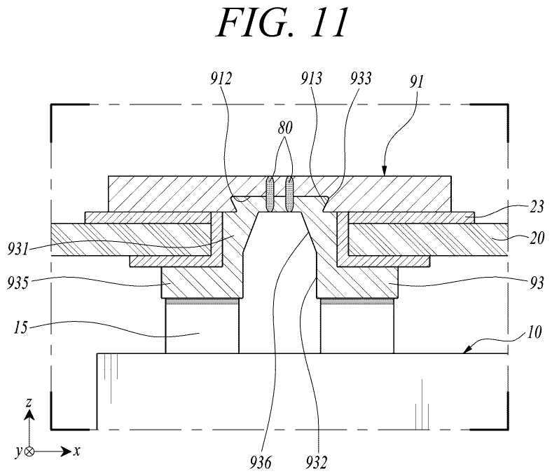

FIG. 11 is a cross-sectional view illustrating a state where a terminal is engaged with a current collecting member according to the fifth embodiment of the present disclosure.

Referring to FIG. 11, since the secondary battery according to the present embodiment has the same structure as the secondary battery according to the third embodiment described above, except for terminals and a current collecting member 93, overlapping descriptions of the same structure will be omitted. Since the second terminal has the same structure as a first terminal 91, the description of the first terminal 91 will replace the description of the second terminal.

The first terminal 91 is formed in a plate shape, and an engagement groove 912 may be formed in the lower surface of the first terminal 91 such that a protrusion is inserted thereinto. The first terminal 91 may be engaged with a protrusion 931 of the current collecting member 93 by compression.

The current collecting member 93 may include a base plate 935 and the protrusion 931 protruding upwardly from the base plate 935 to be inserted into the terminal hole formed in the cap plate 20. The protrusion 931 may be formed in a substantially cylindrical shape.

Further, the current collecting member 93 may include a recess 932 formed in the surface thereof opposite to the protrusion 931. The recess 932 may include a varying inner diameter portion 936 of which the inner diameter gradually decreases upward.

The current collecting member 93 may include a fixing projection 933 projecting from the outer peripheral surface thereof to be inserted into the first terminal 91, and the fixing projection 933 may project from the outer peripheral surface of the protrusion 931. The fixing projection 933 may be formed extending in the circumferential direction of the protrusion 931. The fixing projection 933 may be located on the upper end of the protrusion 931. The fixing projection 933 may be formed in the process of compressing the protrusion 931, and may be formed through a two-step compressing process.

The first terminal 91 may include an engagement projection 913 that is inserted into the outer peripheral surface of the current collecting member 93. The engagement projection 913 is located under the fixing projection 933, and the fixing projection 933 and the engagement projection 913 may support each other by being abutted against each other.

The positive electrode uncoated portion 15 is disposed under the current collecting member 93, and the current collecting member 93 may be directly bonded to the positive electrode uncoated portion 15 without the reinforcing member. The electrode assembly 10 may include a plurality of positive electrode uncoated portions 15 spaced apart from each other in the longitudinal direction of the cap plate 20.

Hereinafter, a secondary battery according to a sixth embodiment of the present disclosure will be described.

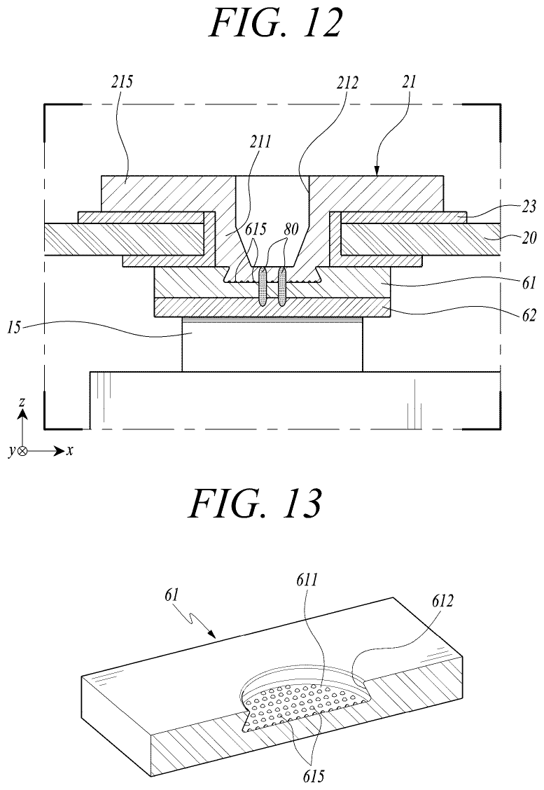

FIG. 12 is a cross-sectional view illustrating a state where a terminal is engaged with a current collecting member according to the sixth embodiment of the present disclosure, and FIG. 13 is a view illustrating the current collecting member according to the sixth embodiment of the present disclosure.

Referring to FIGS. 12 and 13, since the secondary battery according to the present embodiment has the same structure as the secondary battery according to the first embodiment described above, except for the current collecting member 61, overlapping descriptions of the same structure will be omitted.

The first terminal 21 may include the plate-shaped base plate 215, and the protrusion 211 protruding downwardly from the base plate 215 to be inserted into the terminal hole formed in the cap plate 20. Further, the first terminal 21 may include the recess 212 formed in the surface thereof opposite to the protrusion 211.

The engagement groove 611 may be formed in the upper surface of the current collecting member 61 such that the protrusion 211 is inserted thereinto. The plate-shaped current collecting member 61 and the reinforcing member 62 are disposed under the first terminal 21, and the current collecting member 61 may be engaged with the protrusion 211 of the first terminal 21 by compression.

Fine contact projections 615 may be formed in the engagement groove 611, and may be formed on the bottom of the engagement groove 611. Alternatively, the contact projections 615 may be formed on the inner wall surface of the engagement groove 611. The contact projections 615 may have, for example, a hemispherical shape or a polygonal shape, and may be uniformly distributed across the bottom of the engagement groove 611.

When the contact projections 615 are formed in the engagement groove 611 as in the present embodiment, the contact projections 615 may deform and come into close contact with the first terminal 21 during the process of pressing the first terminal 21 and the current collecting member 61, so that the electrical connection between the first terminal 21 and the current collecting member 61 may be enhanced.

Hereinafter, a secondary battery according to a seventh embodiment of the present disclosure will be described.

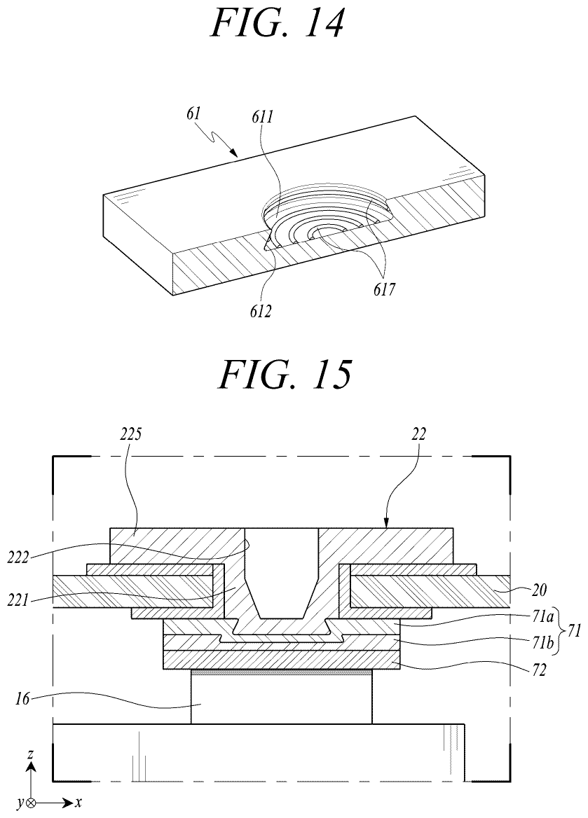

FIG. 14 is a view illustrating a current collecting member according to the seventh embodiment of the present disclosure.

Referring to FIG. 14, since the secondary battery according to the present embodiment has the same structure as the secondary battery according to the first embodiment described above, except for the current collecting member 61, overlapping descriptions of the same structure will be omitted.

The engagement groove 611 may be formed in the current collecting member 61, and a contact rib 617 may be formed in the engagement groove 611. A plurality of contact ribs 617 may be formed on the bottom of the engagement groove 611, and the contact ribs 617 may also be formed on the inner wall surface of the engagement groove 611. The contact ribs 617 may be formed extending in the circumferential direction of the engagement groove 611, and may be formed in a circular ring shape. The plurality of contact ribs 617 may be arranged in the form of concentric circles.

When the contact ribs 617 are formed in the engagement groove 611 as in the present embodiment, the contact ribs 617 may deform and come into close contact with the first terminal 21 during the process of pressing the first terminal 21 and the current collecting member 61, so that the electrical connection between the first terminal 21 and the current collecting member 61 may be enhanced. Further, by the contact ribs 617 formed on the inner wall of the engagement groove 611, the engagement strength between the first terminal and the current collecting member 61 may be further enhanced.

Hereinafter, a secondary battery according to an eighth embodiment of the present disclosure will be described.

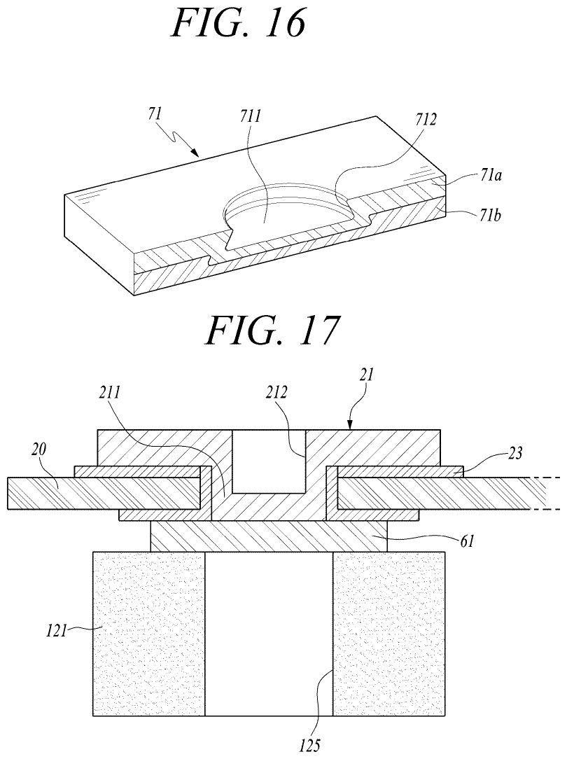

FIG. 15 is a cross-sectional view illustrating a state where a terminal is engaged with a current collecting member according to the eighth embodiment of the present disclosure, and FIG. 16 is a view illustrating the current collecting member according to the eighth embodiment of the present disclosure.

Referring to FIGS. 15 and 16, since the secondary battery according to the present embodiment has the same structure as the secondary battery according to the first embodiment described above, except for the current collecting member 71, overlapping descriptions of the same structure will be omitted.

The second terminal 22 may include the plate-shaped base plate 225, and the protrusion 221 protruding downwardly from the base plate 225 to be inserted into the terminal hole formed in the cap plate 20. Further, the second terminal 22 may include the recess 222 formed in the surface thereof opposite to the protrusion 221.

The engagement groove 711 may be formed in the upper surface of the current collecting member 71 such that the protrusion 221 is inserted thereinto. Further, the current collecting member 71 may include the engagement projection 712 that is inserted into the outer peripheral surface of the second terminal 22.

The plate-shaped current collecting member 71 and the reinforcing member 72 are disposed under the second terminal 22, and the current collecting member 71 may be engaged with the protrusion 221 of the second terminal 22 by compression.

The reinforcing member 72 and the second terminal 22 may be made of different materials. For example, the reinforcing member 72 may be made of copper, and the second terminal 22 may be made of aluminum.

The current collecting member 71 may be made of clad metal. The current collecting member 71 may include a first layer 71a made of a first metal and a second layer 71b disposed under the first layer 71a and made of a second metal. Here, the first metal may be formed of aluminum, and the second metal may be formed of copper.

When the current collecting member 71 is made of clad metal as in the present embodiment, the engagement strength among the second terminal 22, the current collecting member 71, and the reinforcing member 72 may be enhanced.

Hereinafter, a method of manufacturing a secondary battery according to embodiments of the present disclosure will be described.

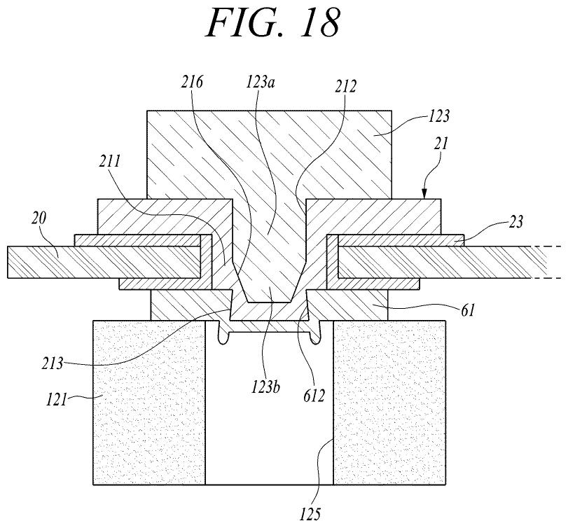

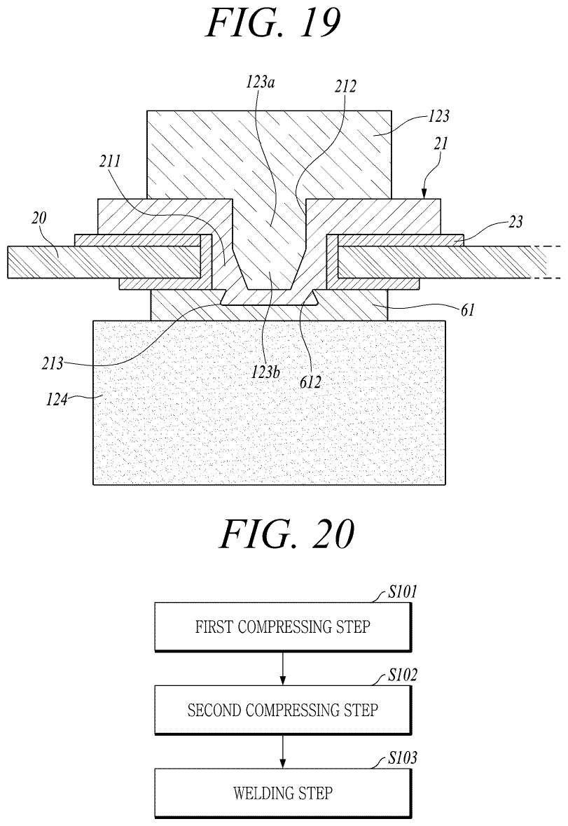

FIG. 17 is a view illustrating a state where a terminal and a current collecting member are placed on a die according to embodiments of the present disclosure. FIG. 18 is a view illustrating a first compressing step according to embodiments of the present disclosure. FIG. 19 is a view illustrating a second compressing step according to embodiments of the present disclosure. FIG. 20 is a flowchart illustrating the method of manufacturing the secondary battery according to embodiments of the present disclosure.

Referring to FIGS. 17 to 20, the method of manufacturing the secondary battery according to the embodiments may include a first compressing step S101, a second compressing step S102, and a welding step S103.

In the first compressing step S101, the first terminal 21 and the current collecting member 61 are placed on a die 121 with a recessed space 125, and a pressing protrusion 123a of a first pressing member 123 is inserted into the recess 212 of the first terminal 21. In this state, the first terminal 21 is pressed toward the current collecting member 61 by using the first pressing member 123. More specifically, in the first compressing step S101, the protrusion 211 is pressed downwardly toward the current collecting member 61 by using the first pressing member 123, such that the protrusion 211 is inserted into the current collecting member 61, forming the engagement groove 611 in the current collecting member 61. At this time, a downwardly protruding portion may be formed at the bottom of the current collecting member 61.

As another example, as illustrated in FIG. 11, in the first compressing step S101, the first terminal 91 and the current collecting member 93 may be placed on the die 121, and the current collecting member 93 may be pressed toward the first terminal 91 by using the first pressing member 123. More specifically, the pressing protrusion 123a of the first pressing member 123 is inserted into the recess 932 of the current collecting member 93, and in this state, the protrusion 931 is pressed toward the first terminal 91 by using the first pressing member 123, so that the protrusion 931 is inserted into the first terminal 91, forming the engagement groove 611 in the first terminal 91. At this time, an upwardly protruding portion may be formed at the top of the first terminal 91.

In the lower end of the first pressing member 123, a tapered portion 123b is formed to have the outer diameter gradually decreasing downward, and thus, in the first compressing step S101, the varying inner diameter portion 216 is formed in the recess 212 to have the inner diameter gradually decreasing toward the bottom of the recess 212 (−z-axis direction).

In the first compressing step S101, various components such as the cap plate 20 and the gasket 23 may be disposed between the first terminal 21 and the current collecting member 61. In the first compressing step S101, the fixing projection 213 may be formed to protrude from the outer peripheral surface of the protrusion 211 and be inserted into the engagement groove 611, and the engagement projection 612 may be formed to project from the inner surface of the engagement groove 611 and be inserted into the outer peripheral surface of the protrusion 211.

As another example, as illustrated in FIG. 11, in the first compressing step S101, the fixing projection 933 is formed in the current collecting member 93 to be inserted into the first terminal 91, and the engagement projection 913 may be formed in the first terminal 91 to be inserted into the outer peripheral surface of the current collecting member 93.

Further, in the first compressing step S101, the recess 932 is pressed using the first pressing member 123 with the tapered portion 123b so that the varying inner diameter portion 936, of which the inner diameter gradually decreases toward the bottom of the recess 932 (z-axis direction), may be formed in the recess 932.

In the second compressing step S102, the first pressing member 123 is inserted into the recess 212 in a state where the current collecting member 61 and the first terminal 21 are placed on a second pressing member 124 having a plane surface without a recessed space, and the lower surface of the current collecting member 61 is pressed using the second pressing member 124 to compress the lower end of the first terminal 21 and the current collecting member 61. At this time, the current collecting member 61 may maintain the plane lower surface, while allowing the insertion of the first terminal 21 and securing the first terminal 21 by compression. Further, in the second compressing step S102, the height of the fixing projection 213 and the engagement projection 612 may be reduced, and as a result, the first terminal 21 and the current collecting member 61 may be firmly fixed.

As another example, in the second compressing step S102, as illustrated in FIG. 11, the upper surface of the first terminal 91 may be pressed using the second pressing member in the state where the first pressing member 123 is inserted into the recess 932, to compress the upper end of the first terminal 91 and the current collecting member 93.

In the welding step S103, the protrusion 211, the current collecting member 61, and the reinforcing member 62 are bonded at once by welding in the state where the reinforcing member 62 is stacked on the lower surface of the current collecting member 61. The bead 80 formed at this time extends from the protrusion 211 to the reinforcing member 62, so that the protrusion 211, the current collecting member 61, and the reinforcing member 62 may be secured.

As another example, as illustrated in FIG. 8, in the welding step S103, the protrusion 211, the current collecting member 61, and the reinforcing member 62 may be bonded by welding in the state where the connection projection 621 of the reinforcing member 62 is inserted into the connection groove 616 formed in the lower surface of the current collecting member 61.

Further, in the welding step S103, as illustrated in FIG. 10, the protrusion 211, the current collecting member 61, and the positive electrode uncoated portion 15 may be bonded by welding without the reinforcing member.

In the welding step S103, a laser may be irradiated from the top of the recess 212 of the first terminal 21, to bond the first terminal 21, the current collecting member 61, and the reinforcing member 62 at once by welding. In the welding step S103, the reinforcing member 62 may be welded to the current collecting member 61 in the state of being fixed to the positive electrode uncoated portion 15.

Through the first compressing step S101 and the second compressing step S102, the first terminal 21 and the current collecting member 61 may be mechanically and stably fixed to each other, and the fixing projection 213 and the engagement projection 612 are formed to be fitted into and engaged with each other, so that the first terminal 21 and the current collecting member 61 may be prevented or suppressed from being disengaged from each other due to vibration or shock, and furthermore, even different types of metals may be bonded effectively.

While embodiments of the present disclosure have been described, one of ordinary skill in the art may make various modifications and changes to the present disclosure by adding, changing, deleting, or adding components within the scope that does not depart from the idea of the present disclosure set forth in the claims, and the modifications and changes also fall within the scope of the present disclosure.

What is claimed is:

1. A secondary battery comprising:
an electrode assembly with a positive electrode and a negative electrode;
a case into which the electrode assembly is inserted;
a cap plate coupled to the case;
a terminal provided on the cap plate; and
a collector electrically connecting the electrode assembly and the terminal,
wherein the terminal and the collector are fitted into and engaged with each other, and the terminal or the collector includes a fixing projection projecting from an outer peripheral surface thereof to be inserted into the collector or the terminal, respectively.

2. The secondary battery according to claim 1, wherein the collector or the terminal includes an engagement projection that is inserted into an outer peripheral surface of the terminal or the collector.

3. The secondary battery according to claim 2, wherein a bottom surface of the collector is planar.

4. The secondary battery according to claim 2, wherein the terminal includes a protrusion that is inserted into the collector, and a recess formed in a surface thereof opposite to the protrusion.

5. The secondary battery according to claim 4, wherein in the recess, a varying inner diameter portion is formed to have an inner diameter gradually decreasing downward.

6. The second battery according to claim 4, wherein an outer surface of the protrusion has a first diameter, and an outer surface of the fixing projection has a second diameter smaller than the first diameter.

7. The secondary battery according to claim 6, wherein an inner surface of the engagement projection has a third diameter smaller than the second diameter and the first diameter.

8. The secondary battery according to claim 4, wherein the collector is compressed against the protrusion to be fixed to the terminal.

9. The secondary battery according to claim 8, wherein the collector is fixed to the protrusion by a two-step compressing process.

10. The secondary battery according to claim 4, wherein an engagement groove is formed in an upper surface of the collector such that the protrusion is inserted thereinto, and the fixing projection is inserted into an inner peripheral surface of the engagement groove.

11. The secondary battery according to claim 1, further comprising:
a reinforcing member disposed under the collector, and configured to electrically connect an uncoated portion of the electrode assembly and the collector.

12. The secondary battery according to claim 11, wherein the reinforcing member is joined to the collector by welding in a state of being bonded to the uncoated portion.

13. The secondary battery according to claim 11, wherein the terminal, the collector, and the reinforcing member are secured by a bead, and the bead is formed to extend from the terminal to the reinforcing member.

14. The secondary battery according to claim 11, wherein a connection groove is formed in a lower surface of the collector, and a connection projection is formed in the reinforcing member to be inserted into the connection groove.

15. The secondary battery according to claim 1, wherein the electrode assembly includes a plurality of positive electrode uncoated portions protruding from the positive electrode, and some of the plurality of uncoated portions are spaced apart from each other in a longitudinal direction of the cap plate,
when a width of each positive electrode uncoated portion is TW11, and a gap between the spaced positive electrode uncoated portions TG11, 1.1<TW11/TG11<2.5 is satisfied.

16. The secondary battery according to claim 15, wherein when the width of each positive electrode uncoated portion is TW11, and a height of each positive electrode uncoated portion is TH11, 1.2<TW11/TH11<3.5 is satisfied.

17. The secondary battery according to claim 16, wherein when the height of each positive electrode uncoated portion is TH11, and the gap between the spaced positive electrode uncoated portions is TG11, 1.01<TH11/TG11<3.1 is satisfied.

18. The secondary battery according to claim 1, wherein when the width of each positive electrode uncoated portion is TW11, the height of each positive electrode uncoated portion is TH11, and the gap between the spaced positive electrode uncoated portions is TG11, 0.74<TW11/(TH11+TG11)<0.98 is satisfied.

19. The secondary battery according to claim 18, wherein the width of each positive electrode uncoated portion is 21 mm to 49 mm, the height of each positive electrode uncoated portion is 13 mm to 33 mm, and the gap between the spaced positive electrode uncoated portions is 5 mm to 31 mm.

20. A secondary battery comprising:
an electrode assembly with a positive electrode and a negative electrode;
a case into which the electrode assembly is inserted;
a cap plate coupled to the case;
a terminal provided on the cap plate; and
a collector configured to electrically connect the terminal and the electrode assembly, and fixed to the terminal by compression.

21. The secondary battery according to claim 20, wherein the electrode assembly includes a plurality of positive electrode uncoated portions protruding from the positive electrode, and some of the plurality of positive electrode uncoated portions are spaced apart from each other in a longitudinal direction of the cap plate,
when a width of each positive electrode uncoated portion is TW11, and a gap between the spaced positive electrode uncoated portions TG11, 1.1<TW11/TG11<2.5 is satisfied.

22. The secondary battery according to claim 21, wherein the width of each positive electrode uncoated portion is TW11, and a height of each positive electrode uncoated portion is TH11, 1.2<TW11/TH11<3.5 is satisfied.

23. The secondary battery according to claim 22, wherein the height of each positive electrode uncoated portion is TH11, and the gap between the spaced positive electrode uncoated portions is TG11, 1.01<TH11/TG11<3.1 is satisfied.

24. The secondary battery according to claim 20, wherein the width of each positive electrode uncoated portion is TW11, the height of each positive electrode uncoated portion is TH11, and the gap between the spaced positive electrode uncoated portions is TG11, 0.74<TW11/(TH11+TG11)<0.98 is satisfied.

25. The secondary battery according to claim 24, wherein the width of each positive electrode uncoated portion is 21 mm to 49 mm, the height of each positive electrode uncoated portion is 13 mm to 33 mm, and the gap between the spaced positive electrode uncoated portions is 5 mm to 31 mm.

26. A method of manufacturing a secondary battery, the method comprising:
a first compressing step of pressing a terminal toward a collector or pressing the collector toward the terminal, by using a first presser in a state where the terminal and the collector are disposed in contact with each other, thereby engaging the collector and the terminal with each other; and
a second compressing step of pressing a lower surface of the collector or an upper surface of the terminal, by using a second presser in a state where the first presser is engaged with the terminal or the collector.

27. The method according to claim 26, wherein in the first compressing step, in a state where the terminal and the collector are placed on a die with a recessed space, a pressing projection formed in the first presser is inserted into a recess formed in the terminal to press the terminal, and an engagement groove is formed in the collector such that a protrusion of the terminal is inserted thereinto.

28. The method according to claim 26, wherein in the first compressing step, in a state where the terminal and the collector are placed on a die with a recessed space, a pressing projection formed in the first presser is inserted into a recess formed in the collector to press the collector, and an engagement groove is formed in the terminal such that a protrusion of the collector is inserted thereinto.

29. The method according to claim 27, wherein in a lower end of the first presser, a tapered portion is formed to have an outer diameter gradually decreasing downward, and
in the first compressing step, a varying inner diameter portion is formed in the recess to have an inner diameter gradually decreasing toward a bottom of the recess.

30. The method according to claim 29, wherein in the first compressing step, a fixing projection is formed to project from an outer peripheral surface of the protrusion and be inserted into the engagement groove, and an engagement projection is formed to project from an inner surface of the engagement groove and be inserted into the outer peripheral surface of the protrusion, and
in the second compressing step, a height of the fixing projection and the engagement projection is reduced.

31. The method according to claim 27, further comprising:
a welding step of, in a state where a plate-shaped reinforcing member is stacked under the collector, bonding the terminal, the collector, and the reinforcing member by welding, and
in the welding step, a bead is formed to extend from the terminal to the reinforcing member.
